(19) United States
(12) Patent Application Publication
(10) Pub. No.: US 2005/0237761 A1
(43) Pub. Date: Oct. 27, 2005

(54) Illuminable display device

(76) Inventor: Andrew Stanley Lasota, Windsor (GB)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 10/514,868

(22) PCT Filed: May 15, 2003
(86) PCT No.: PCT/GB03/02090

§ 371 Date: Jun. 10, 2005

(30) Foreign Application Priority Data
May 16, 2002 (GB) 0211351.2
May 14, 2003 (GB) 0311034.3

(51) Int. Cl. G02B 6/00

(52) U.S. Cl. 362/551

(57) ABSTRACT

The display device comprises a transparent illuminating sheet (1) and a remote source of light. A side-emitting fibre-optic cable (5) transmits light from the source and is so disposed along an edge (3) of the sheet that light is directed into the sheet (1). The sheet (1) overlies material to be displayed and illuminated by light emitted through face (4) of the sheet (1). The image can be viewed through an opposed face. These images may be displayed under subdued illumination, with a profile sufficiently thin to be safely mountable to a vehicle or the like.

The present invention relates to a display device for illuminating an image. More particularly, but not exclusively, it relates to a low profile illuminated display device suitable for use mounted to a vehicle or the like.

It can be difficult to display an image, such as an advertisement, on a vehicle, such that it can be viewed in poor lighting conditions. Where a vehicle or trailer is employed primarily for advertising purposes, it may be provided with arrangements of light sources, such as fluorescent tubes, within the vehicle, etc, to back-light posters and the like. Such arrangements are bulky, however, sacrificing useful space within the vehicle and requiring extensive modification work to fit.

Such a bulky arrangement may not be mounted externally to a vehicle, as road safety regulations in most jurisdictions forbid the fitting of inessential items which extend significantly outwardly from a vehicle. Projecting illuminating means, such as those employed over road signs, are hence also forbidden. Road safety regulations normally also restrict the brightness of illumination that can be emitted from a vehicle, particularly a moving vehicle, other than for safety purposes.

Highly-reflective coatings, such as are frequently used on road signs and number plates, are far too expensive for temporary use, and in any case require an observer to shine his or her own light source on them.

Advertising signage on vehicles is hence currently restricted mainly to printed vinyl sheets, applied with adhesive to the sides and/or rear of vans, trucks, lorries, trailers and the like. These sheets are very expensive to produce, a sheet to cover one side of a small lorry at present costing around £1500. Printing on to vinyl is significantly more expensive than on to paper, for example, and all the materials used must be weather-resistant, and pigments must not fade in direct sunlight. To be economically viable, therefore, such sheets must be left in place for prolonged periods.

Even then, signage of this type cannot easily be seen under poor illumination. Hence there is a need for a means of illuminating signage which is not bulky, which can be fitted to a vehicle without major alterations, which can illuminate a sign sufficiently for it to be read while not conflicting with road safety regulations, and which does not require temporary signage to be made from expensive raw materials.

It is known to produce permanent signs and display boards using a material known as “edge-lit” light diffusing sheet. This is a sheet of clear plastics material, normally comprising polymethylmethacrylate, which has been treated so that light directed into the sheet from an edge is scattered diffusely outwardly from one or both faces of the sheet. This is conventionally used in conjunction with a fluorescent striplight disposed adjacent one edge of the sheet, a drawback of this being that the net thickness of the arrangement is still relatively great. It also requires an electrical power supply to the fluorescent light, which restricts its usefulness when exposed to the weather.

It is hence an object of the present invention to provide a means of displaying images under subdued illumination, with a profile sufficiently thin to be safely mountable to a vehicle or the like, and which obviates the problems described above.

According to the present invention, there is provided a display device comprising an illuminating sheet of substantially transparent material, a source of light remote therefrom, a side-emitting fibre-optic cable element to transmit light from said source and so disposed along at least one edge of the sheet as to direct the light into the sheet through said at least one edge, said sheet being adapted to contact the material to be displayed and so diffuse the light as to illuminate the displayed material.

The cable element may be disposed along each edge of said illuminating sheet.

Alternatively, the display device may be provided with a plurality of side-emitting fibre-optic cable elements each disposed along one or more edges of the illuminating sheet.

Preferably, the or a side-emitting fibre-optic cable element is disposed along each one of two substantially opposite edges of said illuminating sheet.

Preferably, the display device is provided with light-reflecting means so disposed around the or each side-emitting fibre-optic cable element as to redirect light emitted therefrom towards a corresponding adjacent edge of the illuminating sheet.

The or each cable element may be mounted to the illuminating sheet with adhesive tape means, which may comprise inwardly light-reflective adhesive tape.

The display device may be provided with frame means to enclose each edge of the illuminating sheet and the or each cable element protectingly and concealingly.

The display device may be provided with a transparent cover sheet, preferably of a plastics material of greater hardness and mar resistance than a plastics material comprising the illuminating sheet, and mounted to an outer face of the illuminating sheet.

The cover sheet is preferably mounted in direct face-to-face contact with or laminated to the illuminating sheet, and may be enclosed at each edge by said frame means.

The material to be displayed may conveniently be a sheet of paper or the like bearing an image printed thereon.

The display device may comprise a mounting unit, fixable to a substrate, to which the illuminating sheet is mounted hingeably, slideably or detachably, optionally via said frame means, to allow insertion or removal of the material to be displayed.

The display device is preferably adapted to be mounted to a vehicle, for example a van, a lorry, a trailer or a bus.

The light source may then be disposed within the vehicle.

Alternatively, the display means may be adapted to be mounted to a stationary structure, such as a building, and the light source may be disposed within said structure or within an adjacent structure.

A single light source may be used to illuminate two or more displays.

Embodiments of the invention will now be more particularly described by way of example and with reference to the accompanying drawings, in which:

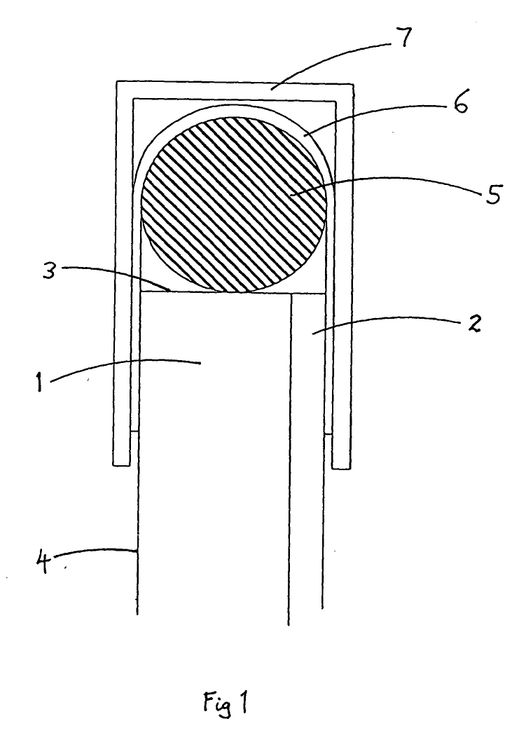

FIG. 1 shows in cross-section a peripheral zone of a display device embodying the invention;

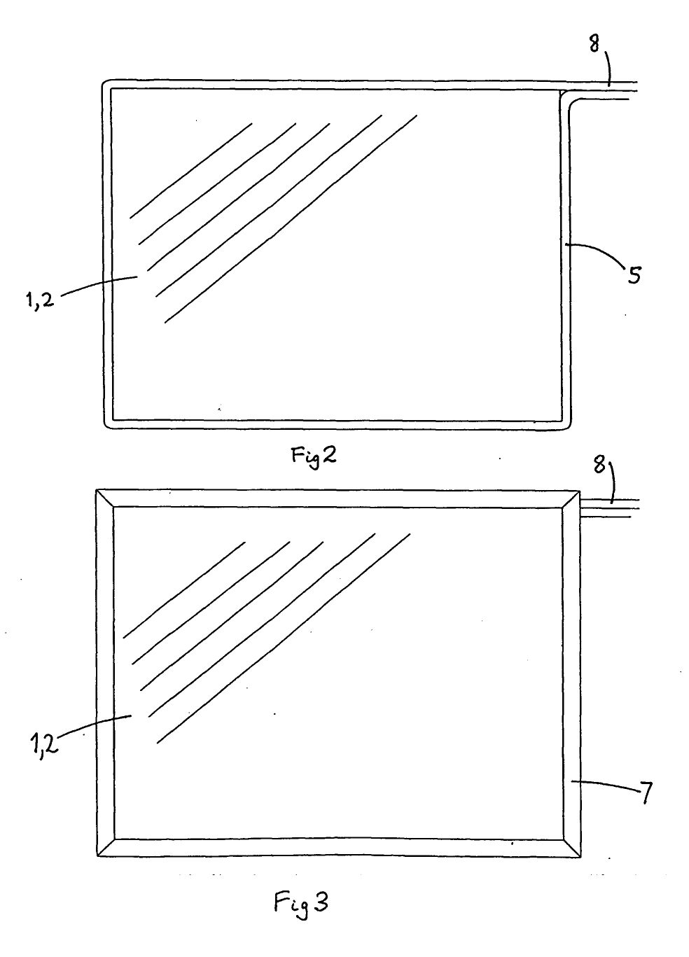

FIG. 2 is a front elevation of the display device of FIG. 1 with its frame omitted;

FIG. 3 is a front elevation of the display device of FIG. 1 with its frame in place;

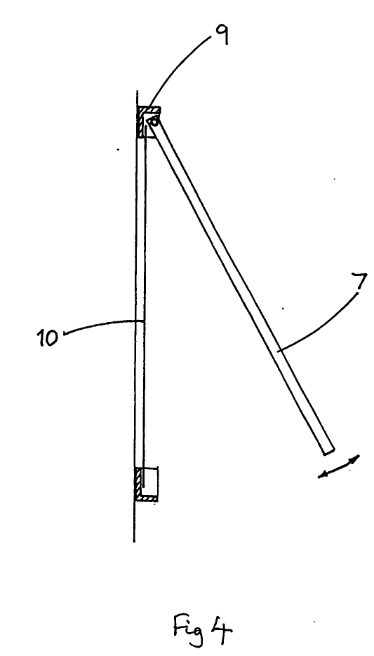

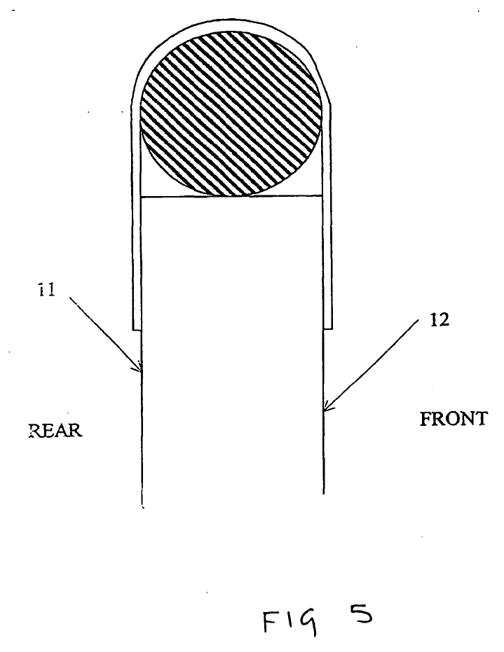

FIG. 4 a shows in schematic cross-section a mounting arrangement for the display device; and

FIG. 5 shows a second embodiment of the invention adapted for back-lighting an image.

Referring now to the Figures and to FIG. 1 in particular, a display device comprises a light transmission sheet 1 of clear plastics material, preferably an acrylate or methacrylate polymer, and a cover sheet 2 of clear but harder plastics material mounted in face-to-face contact therewith.

The transmission sheet 1 is adapted to be “edge-lit”, a proportion of light entering the sheet 1 through an edge 3 thereof being emitted diffusely through one face 4 of the sheet 1. Suitable sheets are marketed in Europe by Atofina under the trade name ALTUGLAS® CN Elit and by Ineos Acrylics under the trade name PRISMEX.

The cover sheet 2 comprises a harder, more scratch-resistant material than the transmission sheet 1. (Transmission sheets 1 currently available are formed of relatively low-hardness materials and/or have relatively delicate surface features).

A side-emitting fibre-optic cable 5 is disposed along the edge 3 of the sheet 1, and is held in place by a strip of adhesive reflective tape 6. Light from the fibre-optic cable 5 is thus directed into the sheet I through the edge 3 thereof.

A frame element 7 encases the fibre-optic cable 5 and the sheets 1, 2 adjacent the edge 3 for protection and aesthetic purposes. The frame element 7 conveniently comprises an extruded aluminium channel section, though frame elements of plastics materials are also envisaged.

In the embodiment shown in FIGS. 2 and 3, the fibre-optic cable 5 is disposed along each edge of a rectangular transmission sheet I and cover sheet 2 assembly, and an extended portion 8 of the cable 5 leads to a light source (not shown) positioned remotely from the display device.

In other possible embodiments, the side-emitting fibre optic cable 5 may extend along only one, two or three edges of the sheets 1, 2, depending on the degree of illumination required and the area of the device to be illuminated. The edges 3 of the transmission sheet 1 adjacent the cable 5 are polished; other edges need not be. The device is shown as rectangular, but most regular and irregular two-dimensional shapes are possible, optionally with particularly acutely angled corners radiussed to accommodate the cable 5.

The image to be displayed is mounted behind an inner face 4 of the transmission sheet 1. Light from the side-emitting fibre-optic cable 5 enters the sheet 1 through its edge 3 and is diffused through face 4 on to the image. The illuminated image is then viewed through the cover sheet 2 and the transmission sheet 1.

“Edge-lit” transmission sheet 1 with a thickness of eight to ten millimetres can be illuminated as described up to around 800 millimetres from a single illuminated edge. A transmission sheet 1 with a thickness of fifteen to twenty millimetres can be illuminated up to a total width of around 2.5 metres, when illuminated from two opposite edges.

Side-emitting fibre-optic cable 5 currently available is capable of radially emitting light of effectively constant intensity over a length of around thirty metres from a conventional light source. The comparatively bulky light source can thus be mounted conveniently remotely from the display device (for example, within a vehicle cab) which also isolates it and its electrical power supply from poor weather or vandalism.

The display device and the fibre-optic cable 5, 8 supplying it with light can thus be produced with a very thin overall profile, suitable for mounting to an exterior surface of a vehicle, for example, without significantly increasing its width. Being thin, the display device is also relatively light and can normally be mounted to a substrate without the need for elaborate load-bearing mountings. Furthermore, it is more resistant to vandalism or disfigurement.

A particularly convenient mounting arrangement is shown in FIG. 4. A fixed frame 9 (here shown with exaggerated thickness for clarity) is mounted to a substrate, such as a side of a vehicle, and the display device is hingeably mounted thereto via its frame elements 7. The display device may thus be swung away from the fixed frame 9, as shown, and a sheet 10 bearing an image to be displayed may be mounted to the fixed frame 9 so that it is disposed between the fixed frame 9 and the display unit when the latter is swung back into place.

This arrangement allows rapid and convenient installation, removal and replacement of an image such as an advertisement of short-term applicability. When in place, each image is illuminable at will, and is protected from the effects of the weather. The sheet 10 bearing the image can thus comprise a cheap and convenient material, such as paper, and the image may also be printed using conventional, non-durable inks, as it is shielded from natural ultraviolet irradiation when in place.

While the display device is described above in terms of its use on a vehicle or the like, it may also be of benefit in other situations. Street advertising, for example, often involves the use of bulky arrangements of fluorescent tubes or the like to backlight posters. This restricts where they can be positioned, the light sources are open to vandalism, and it is inconvenient to change defunct fluorescent tubes, etc. A display device as described above can easily be affixed to a wall, with its light source elsewhere, for example within a building, protected from attack and more easily accessible for maintenance.

Referring to the embodiment shown in FIG. 5, the device can also operate as a rear-illumination (“light box”) device for any aspect that requires slip illumination where conventional lighting techniques cannot be used.

A reflective white self-adhesive material (white vinyl) is applied to the rear 11 of the acrylic sheet 1 thus directing light to the front of the material, enhancing the illumination properties.

With this application, it is possible for the front 12 of the device to be used as a “face” to hold adhesive vinyl prints or coloured Perspex sheets for shop-signage and the like that require illumination of the type seen in retail high streets above shop entrances.

In this situation, it would not be necessary for the device to be protected by a covering sheet. The material can be applied directly to the face of the illuminable acrylic sheet.

For example, where signage is sufficiently high and difficult to access without cranes for maintenance (replacement of bulbs, tubes, etc), then it is possible for this invention to be used as a rear illumination with the “light box” being located conveniently for easy maintenance.

It allows for the benefit of easy installation with no electrical connections being made within the sign itself. This reduces maintenance and installation costs.

A display device as described may also be conveniently employed in conjunction with more elaborate images, for example those produced by liquid crystal displays.

1. A display device comprising an illuminating sheet of substantially transparent material, a source of light remote therefrom, a side-emitting fibre-optic cable element to transmit light from said source and so disposed along at least one edge of the sheet as to direct the light into the sheet through said at least one edge, said sheet being adapted to contact the material to be displayed and so diffuse the light as to illuminate the displayed material.

2. A device as claimed in claim 1, wherein the cable element is disposed along each edge of said illuminating sheet.

3. A device as claimed in claim 1, wherein the display device is provided with a plurality of side-emitting fibre-optic cable elements each disposed along one or more edges of the illuminating sheet.

4. A device as claimed in claim 1, wherein the or a side-emitting fibre-optic cable element is disposed along each one of two substantially opposite edges of said illuminating sheet.

5. A display device as claimed in claim 1, further comprising light-reflecting means so disposed around the or each side-emitting fibre-optic cable element as to redirect light emitted therefrom towards a corresponding adjacent edge of the illuminating sheet.

6. A device as claimed in claim 5, wherein the or each cable element is mounted to the illuminating sheet with inwardly light-reflective adhesive tape.

7. A device as claimed in claim 1, further comprising frame means to enclose each edge of the illuminating sheet and the or each cable element protectingly and concealingly.

8. A display device as claimed in claim 1, further comprising a transparent cover sheet, preferably of a plastics material of greater hardness and mar resistance than a plastics material comprising the illuminating sheet, and mounted to an outer face of the illuminating sheet.

9. A device as claimed in claim 8, wherein the cover sheet is mounted in direct face-to-face contact with or laminated to the illuminating sheet.

10. A device as claimed in claim 1, wherein the material to be displayed is a sheet of paper or the like bearing an image printed thereon.

11. A device as claimed in claim 1, further comprising a mounting unit, fixable to a substrate, to which the illuminating sheet is mounted hingeably, slideably or detachably to allow insertion or removal of the material to be displayed.

12. A device as claimed in claim 1, and adapted to be mounted to a vehicle, with the light source disposed within the vehicle.

13. A device as claimed in claim 1, and adapted to be mounted to a stationary structure, such as a building, with the light source disposed within said structure or within an adjacent structure.

14. A device as claimed in claim 1, wherein a single remote light source is used to illuminate two or more displays.

15. (canceled)
